(19) United States
(12) Patent Application Publication
(10) Pub. No.: US 2015/0212609 A1
(43) Pub. Date: Jul. 30, 2015

(54) LIGHT BLOCK FOR TRANSPARENT TOUCH SENSORS

(71) Applicant: Apple Inc., Cupertino, CA (US)

(72) Inventors: Chun-Hao TUNG, Luzhu Township (TW); Ohseung KWON, Sunnyvale, CA (US); Sunggu KANG, San Jose, CA (US); John Z. ZHONG, Saratoga, CA (US)

(73) Assignee: Apple Inc., Cupertino, CA (US)

(21) Appl. No.: 14/166,793

(22) Filed: Jan. 28, 2014

(51) Int. Cl. G06F 3/041; B05D 5/00; B05D 1/36

(52) U.S. Cl. CPC G06F 3/041; B05D 1/36; B05D 5/00; G06F 2203/04103

(57) ABSTRACT

A touch sensor panel including one or more conductive sections disposed in an outer area of a touch sensor panel is disclosed. The touch sensor panel stackup can include a substrate, one or more underlying layers, one or more patterned transparent conductive layers, and one or more conductive sections. In some examples, the stackup can include one or more passivation layers. The one or more underlying layers, patterned transparent conductive layers, one or more conductive sections, and passivation layers can be deposited on the same side of the substrate, on different sides of the substrate, or on different substrates. The one or more conductive sections can block unwanted light from penetrating to one or more layers of the touch sensor stackup and preventing changes to the properties of the one or more layers of the stackup.

### FIELD

This relates generally to touch sensor devices, and in particular, to a process for fabricating touch sensor panels for touch sensitive devices.

### BACKGROUND

Touch sensitive devices have become popular as input devices to computing systems due to their ease and versatility of operation, as well as their declining price. A touch sensitive device can include a touch sensor panel, which can be a clear panel with a touch sensitive surface, and a display device, such as a liquid crystal display (LCD). The touch sensitive device can allow a user to perform various functions by touching the touch sensor panel using a finger, stylus or other object at a location often dictated by a user interface (UI) being displayed by the display device. In general, the touch sensitive device can recognize a touch event and the position of the touch event on the touch sensor panel, and a computing system can interpret the touch event in accordance with the display appearing at the time of the touch event, and thereafter can perform one or more actions based on the touch event.

The touch sensor panel can be positioned partially or fully in front of the display device so that the touch sensitive surface covers the viewable area of the display. To enhance the visibility of the display, the layers of touch sensor panel stackup, including the substrate, can be made transparent. However, the transparency of the layers in the touch sensor stackup can lead to unwanted light penetration, which can change or alter the properties of the other layers in the stackup. Changes in the properties of other layers in the stackup can lead to unwanted effects, such as peeling of the layers, subsequently affecting the performance of the touch sensor panel.

### SUMMARY

This relates to a touch sensor panel including one or more conductive sections to reduce or prevent unwanted light penetration to layers in the touch sensor stackup. The layers of a touch sensor stackup can be exposed to unwanted light, resulting in changes in the properties of those layers. Including one or more conductive sections can reduce or eliminate unwanted light penetration to layers of the touch sensor panel stackup to prevent deleterious effects, such as peeling of the layers. In some examples, the one or more conductive sections can be electrically isolated from the rows, columns, and routing traces of the touch sensor panel to prevent any increases in parasitic capacitance and prevent any increases in power consumption. In some examples, the one or more conductive sections can be disposed in the outer areas of the touch sensor panel.

### BRIEF DESCRIPTION OF THE DRAWINGS

FIG. 1A illustrates an exemplary touch sensor that can be used to detect touch events on a touch sensitive device.

FIG. 1B illustrates a side view of an exemplary touch region in a steady-state (no-touch) condition.

FIG. 1C illustrates a side view of an exemplary pixel in a dynamic (touch) condition.

FIG. 2 illustrates an exploded perspective view of an exemplary DITO stackup (with its thickness greatly exaggerated for purposes of illustration only) with column traces and row traces formed on either side according to examples of the disclosure.

FIG. 3 illustrates an exemplary capacitive touch sensor panel fabricated using a double-sided ITO (DITO) substrate having column and row traces, respectively, formed on either side of the substrate, and bonded between a cover and a display using a transparent adhesive, according to examples of the disclosure.

FIGS. 4A-4B illustrates a cross-sectional view of an exemplary DITO stackup according to examples of the disclosure.

FIG. 5 illustrates an exemplary process for manufacturing a DITO stackup according to examples of the disclosure.

FIG. 6A illustrates a cross-sectional view of an exemplary DITO touch sensor stackup with one or more conductive sections according to examples of the disclosure.

FIG. 6B illustrates a top view of an exemplary DITO touch sensor stackup with one or more conductive sections according to examples of the disclosure.

FIGS. 7A-7D illustrate a close up view of exemplary conductive sections.

FIG. 8 illustrates an exemplary computing system that can utilize a touch controller according to various examples of the disclosure.

FIGS. 9A-9C illustrate an exemplary mobile telephone, exemplary media player, and exemplary personal computer that can include a touch sensor panel and a display device according to examples of the disclosure.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

This disclosure relates to a touch sensor panel including one or more conductive sections disposed in some examples in an outer area of a touch sensor panel. The touch sensor panel stackup can include a substrate, one or more underlying layers, one or more patterned transparent conductive layers, and one or more conductive sections. In some examples, the stackup can include one or more passivation layers. The one or more underlying layers, patterned transparent conductive layers, one or more conductive sections, and passivation layers can be deposited on the same side of the substrate, on different sides of the substrate, or on different substrates. The one or more conductive sections can block unwanted light from penetrating to one or more layers of the touch sensor stackup and preventing changes to the properties of the one or more layers of the stackup.

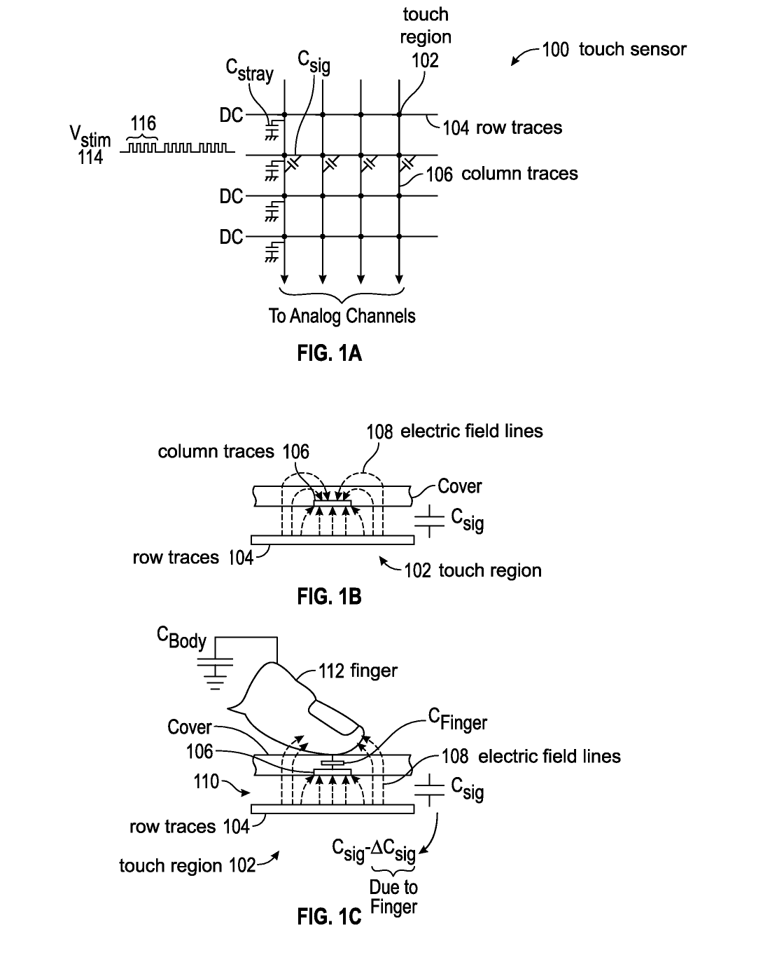

FIG. 1A illustrates an exemplary touch sensor 100 that can be used to detect touch events on a touch sensitive device, such as a mobile phone, tablet, touchpad, portable computer, portable media player, or the like. Touch sensor 100 can include a plurality of row traces 104 and column traces 106. A stray capacitance Cstray can be present at each touch region 102 located at the intersection of a row trace 104 and a column trace 106. For purposes of simplifying the figure, Cstray is illustrated in FIG. 1A for only one column. An associated mutual capacitance Csig can form at the touch regions 102. While the example shown in FIG. 1A includes four row traces 104 and four column traces 106, it should be appreciated that touch sensor 100 can include any number of row traces 104 and any number of column traces 106 to form the desired number and pattern of touch regions 102. Additionally, while the row traces 104 and column traces 106 are shown in FIG. 1A in a crossing configuration, it should be appreciated that other configurations are also possible to form the desired touch region pattern. While FIG. 1A illustrates mutual capacitance touch sensing, other touch sensing technologies may also be used in conjunction with examples of the disclosure, such as self-capacitance touch sensing, resistive touch sensing, projection scan touch sensing, and the like. Furthermore, while various examples describe a sensed touch, it should be appreciated that the touch sensor 100 can also sense a hovering object and generate hover signals therefrom.

Touch sensor panels can be implemented with multiple rows (e.g. drive lines) crossing over multiple columns (e.g. sense lines), where the drive lines and sense lines can be separated by a dielectric material. In some touch sensor panels, the drive and sense lines can be formed on the top and bottom sides of the same transparent substrate. In other touch sensor panels, the drive and sense lines may be formed on one side of the transparent substrate. In some examples, drive and sense lines can be formed on different substrates, and the different substrates can be bonded together using an adhesive. In some examples, at least one of the drive lines and sense lines can be formed on the back of a cover glass. The drive lines and sense lines can be formed from a substantially transparent material, such as Indium Tin Oxide (ITO), although other materials can also be used. The ITO layer(s) can be deposited on one or both sides of the transparent substrate. Touch sensor panels with double or single sided ITO layers are referred to as double-sided ITO (DITO) touch sensor panels and single-sided ITO (SITO) touch sensor panels, respectively, in the disclosure.

FIG. 1B illustrates a side view of exemplary touch region 102 in a steady-state (no-touch) condition. At the intersection of a row trace 104 and column trace 106, an electric field with electric field lines 108 can form. FIG. 1C illustrates a side view of exemplary pixel 102 in a dynamic (touch) condition. Finger or object 112 can be placed near or touching touch region 102. Finger 112 can be a low-impedance object at signal frequencies, and can have an AC capacitance Cfinger from the column trace 104 to the body. The body can have a self-capacitance to ground Cbody, which can be much larger than Cfinger. If finger 112 blocks some electric field lines 108 between row and column traces (the fringing fields that exit the dielectric 110 and pass through the air above the row trace), those electric field lines can be shunted to ground through the capacitance path inherent in the finger and the body, and as a result, the steady state signal capacitance Csig is reduced by ΔCsig. In other words, the combined body and finger capacitance act to reduce Csig by an amount ΔCsig (which can also be referred to herein as Csig_sense), and can act as a shunt or dynamic return path to ground, blocking some of the electric field lines and resulting in a reduced net signal capacitance. The signal capacitance at the signal becomes Csig-ΔCsig, where Csig represents the static (no touch component) and ΔCsig represents the dynamic (touch) component. Note that Csig-ΔCsig may always be nonzero due to the inability of a finger, palm, or other object to block all electric fields, especially those electric fields that remain entirely within the dielectric material 110. In addition, it should be understood that as a finger is pushed harder or more completely onto the multi-touch panel, the finger can tend to flatten, blocking more and more of the electric fields, and thus ΔCsig can be variable and representative of how complete the finger is pushing down on the panel (i.e. a range from “no-touch” to “full-touch”).

Referring again to FIG. 1A, in some examples a stimulation signal Vstim 114 can be applied to a row in the multi-touch panel 100 so that a change in signal capacitance can be detected when a finger, palm, or other object is present. Vstim signal 114 can be generated as one or more pulse trains 116 at a particular frequency, with each pulse train including a number of pulses. The pulse train can be square waves, or other waveshapes, such as sine waves can be employed. A plurality of pulse trains at different frequencies can be transmitted for noise reduction purposes to detect and avoid noisy frequencies. Vstim signal 114 essentially injects a charge into the row, and can be applied to one row of the multi-touch panel at a time, while all other rows are held at a DC level. In some examples, the multi-touch panel can be divided into two or more sections, with Vstim signal 114 being simultaneously applied to one row in each section and all other rows in that region section held at a DC voltage. In other examples, a plurality of rows can be stimulated at the same time, using signals of various frequencies and/or phases.

Column traces can be coupled to analog channels to measure the mutual capacitance formed between that column and the row when a finger or object is present. The column values provided by the analog channels may be provided in parallel while a single row is being stimulated, or may be provided in series. If all of the values representing the signal capacitances for the columns have been obtained, another row in multi-touch panel can be stimulated with all others held at a DC voltage, and the column signal capacitance measurements can be repeated. Eventually, if Vstim 114 has been applied to all rows, and the signal capacitance values for all columns in all rows have been captured (i.e. the entire multi-touch panel has been “scanned”), a “snapshot” of all touch region values can be obtained for the entire multi-touch panel 100. This snapshot data can be initially saved in the multi-touch subsystem, and later transferred out for interpretation by other devices in the computing system such as the host processor. As multiple snapshots are obtained, saved, and interpreted by the computing system, it is possible for multiple touches to be detected, tracked, and used to perform other functions. In examples where a plurality of rows are stimulated at the same time, the column values can represent composite signals that can be processed to determine the image of touch.

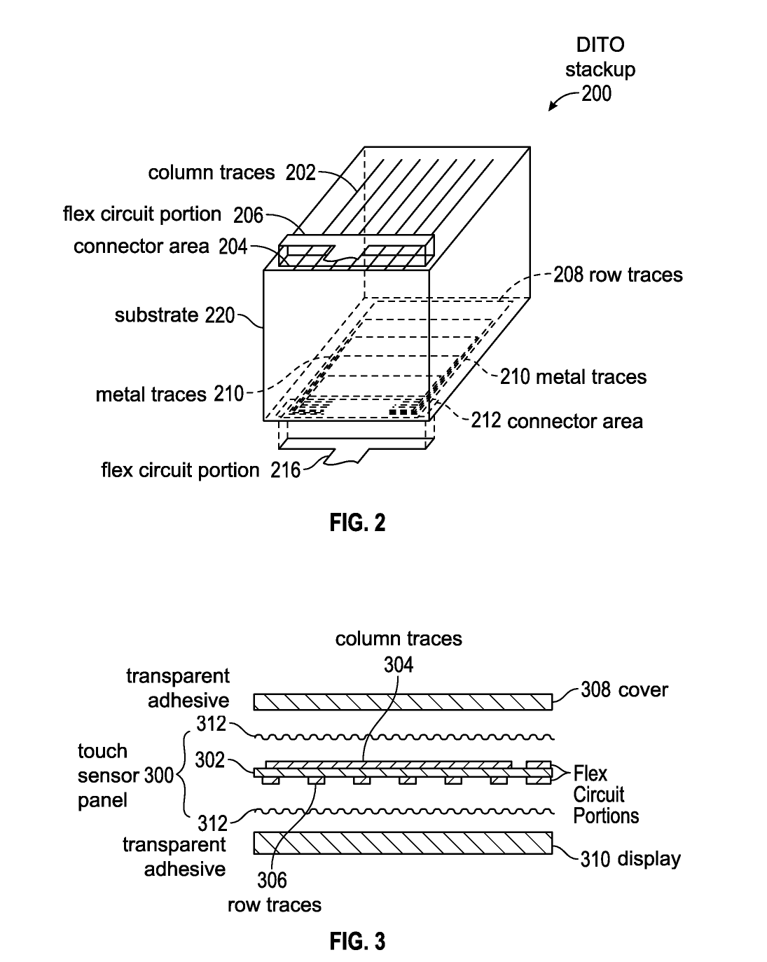

FIG. 2 illustrates an exploded perspective view of an exemplary DITO stackup 200 (with its thickness greatly exaggerated for purposes of illustration only) with column traces 202 and row traces 208 formed on either side according to examples of the disclosure. The column traces 202 on the top side can be routed to a necked-down connector area 204, which then route the signals off panel by a flex circuit portion 206 that can be conductively bonded to the top of DITO substrate 200. In some examples, row traces 208 on the bottom side can be connected to thin metal traces 210 that run alongside the edges of the bottom side. Metal traces 210 can be routed to connector area 212, which can be directly opposing connecting area 204, or at least on the same edge of the substrate 220 as connector area 204. Providing connector areas 204 and 212 at the same edge of the DITO stackup 200 can allow the substrate, and therefore the product, to be smaller. Another flex circuit portion 216 can be used to bring row traces 208 off the panel.

FIG. 3 illustrates an exemplary capacitive touch sensor panel 300 fabricated using a double-sided ITO (DITO) substrate 302 having column and row traces 304 and 306, respectively, formed on either side of the substrate, and bonded between cover 308 and display 310 using transparent adhesive 312 according to examples of the disclosure. Substrate 302 can be made of any transparent substrate material, such as plastic, glass, quartz, or a rigid or flexible composite. Cover 308 can be formed from glass, acrylic, sapphire, and the like. To connect to column and row traces 304 and 306, respectively, two flex circuit portions can be bonded to directly opposing sides at the same edge of the DITO substrate 302, although other bonding locations may also be employed.

Column and row traces can be formed on both sides of the DITO stackup using several fabrication methods. In one example, the substrate can be placed on rollers of the fabrication machinery and a layer of ITO can be sputtered onto a first side of the substrate and etched (e.g. using photolithography techniques) to form column traces. One or more other layers, such as an index matching layer, in the stackup can be formed before or after the column traces are formed. A protective coating can be applied over the column traces, and the substrate can be flipped over so that the rollers make contact only with the applied protective coating on the first side and not the formed column traces. Another layer of ITO can be sputtered onto the now-exposed back side of the substrate and etched to form row traces. One or more other layers, such as an index matching layer, in the stackup can be formed before or after the row traces are formed. Metal traces can be formed at the edges of the substrate to connect to row traces by sputtering a metal layer over the photoresist and exposed edges and then etched. Finally, all remaining layers of photoresist can be stripped off.

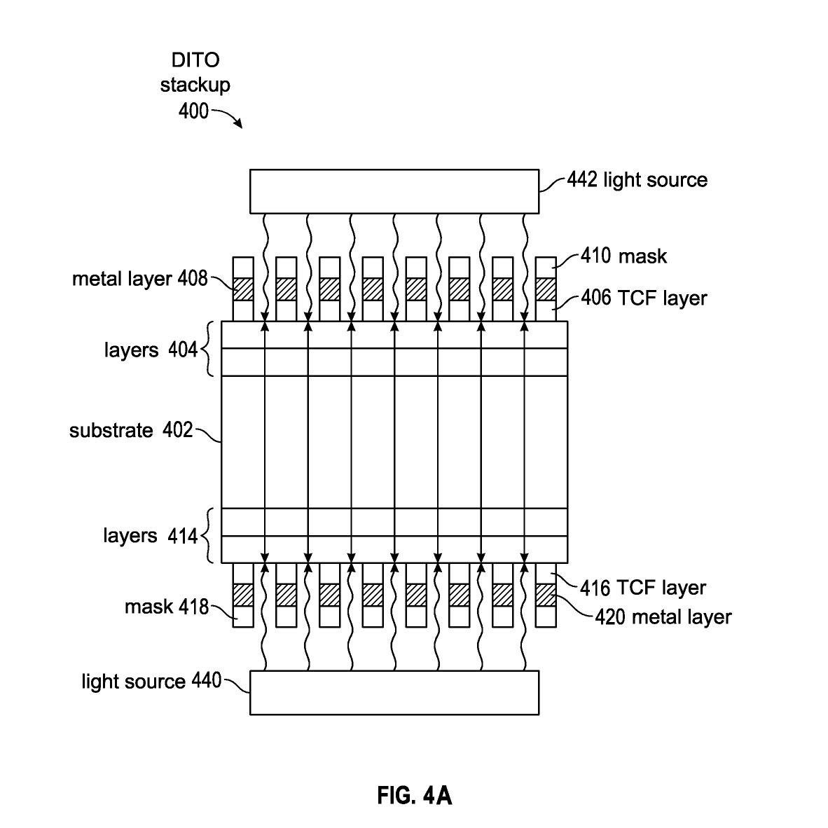

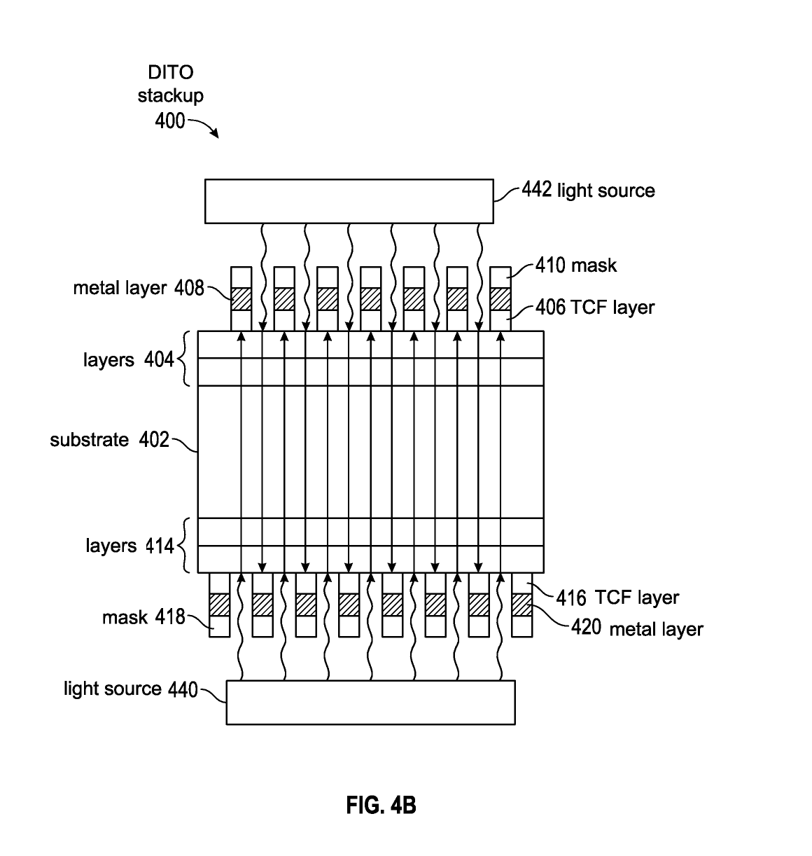

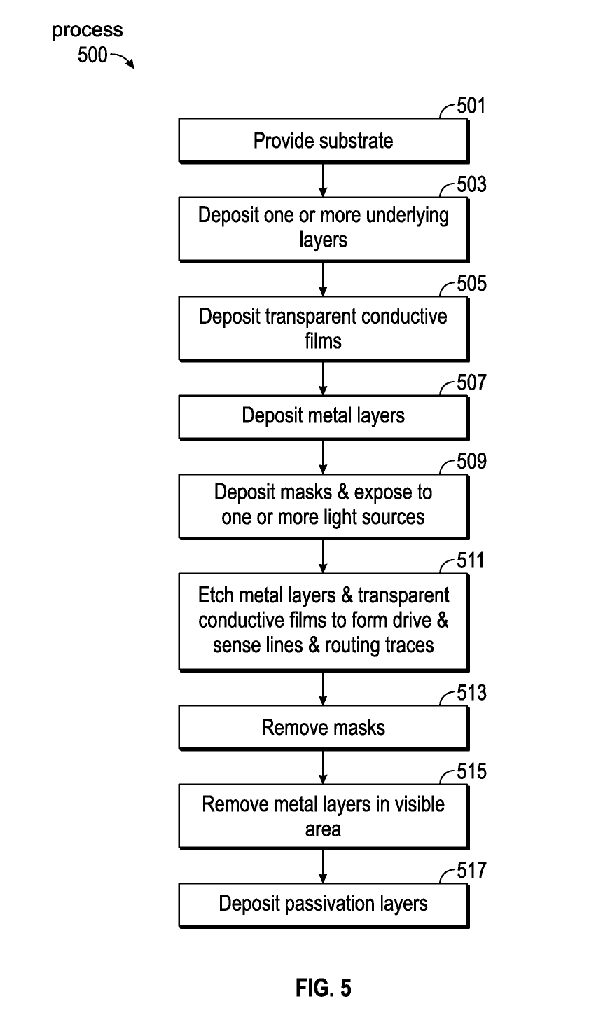

In some examples, both sides of the DITO stackup can be formed simultaneously. FIG. 4A illustrates a cross-sectional view of an exemplary DITO stackup 400, and FIG. 5 illustrates an exemplary process 500 for manufacturing the DITO stackup. At block 501, a substrate 402 can be provided, and at block 503, one or more layers 404 and 414, such as a hard coating layer and/or an index matching layer, can be disposed on the substrate 402. At block 505, transparent conductive films (TCF) layer 406 and 416 can be deposited for the drive and sense lines. TCF layers 406 and 416 can be any electrically conductive material including, but not limited to, Indium Tin Oxide (ITO), Indium Zinc Oxide (IZO), Zinc-doped Indium Tin Oxide (ITZO), Silver nanowires (AgNW), Silver chloride (AgCl), Carbon nanotubes (CNT), Graphene, other metals, other oxides, or the like. At block 507, metal layers 408 and 420 can be deposited for routing traces for the drive and sense lines of the touch sensor structure 400. The metal layers 408 and 420 can be made of copper or any other metal suitable for routing signals on the touch sensor structure. At block 509, masks 410 and 418 can be deposited. TCF layer 406 and metal layer 408 can be patterned to form the drive lines and routing traces for the drive lines by depositing the mask 410. Similarly, transparent conductive film 416 and metal layer 420 can be patterned to form the sense lines and routing traces for the sense lines by depositing the mask 418. Masks 410 and 418 can include any light sensitive material, such as photoresist. Exposure of portions of the masks 410 and 418 to light, such as ultraviolet (UV) light, can alter the chemistry of the mask and change one or more properties, such as solubility, relative to the unexposed portions. In some examples, layers 404 and 414, TCF layers 406 and 416, metal layers 408 and 420, and masks 410 and 418 can be formed at the same time. Light sources 440 and 442 can be directed at both sides of the DITO stackup 400 for exposing portions of the masks 410 and 418 to form a pattern to be transferred to the metal layers 408 and 420 and TCF layers 406 and 416. The patterns for the drive and sense lines and routing traces can be formed by etching, as shown in block 511. (It should be understood that the patterns in the masks, conductive films and metal layers shown in FIG. 4 are only symbolic.) At block 513, masks 410 and 418 can be removed. At block 515, metal layers 408 and 420 in the visible area of the touch sensor structure can be removed, and an optional passivation layer can be deposited on top, at block 517. Passivation layer can be made of any material that can protect and/or planarize the touch sensor structure 400 including any organic material, such as a polymer or an optically clear adhesive. In some examples, masks 410 and 418 can serve as a multi-purpose material and may act not only as a mask during patterning, but also as a passivation layer.

In order to reduce power consumption required by the display and to reduce loss in image quality from the display being positioned behind the touch sensor panel, the touch sensor panel stackup can be been developed using high transparency, low reflection materials. As the layers in the stackup become more and more transparent, light, such as UV light, can penetrate through one side of the DITO stackup and partially or fully sensitize the other side of the DITO stackup. In some examples, light directed at both sides of the DITO stackup can penetrate through and both sides can be sensitized. The conductive film layer in the center area of the touch sensor panel can provide some amount of shielding from UV light. The metal routing traces can also act as a light shielding layer; however, the fabrication of the DITO stackup can be susceptible to even slight misalignment of one side relative to the other (shown in FIG. 4B). Because the coverage and shielding provided by the metal routing traces and the conductive film layer often end in the border area of the touch sensor panel, the outer area (the area outside or beyond the border area to the edge of the touch sensor panel where no metal or conductive material exists) can be vulnerable to light penetration. As a result, a slight misalignment and exposure of the outer area can lead to partially or fully sensitized areas, and the partially or fully sensitized areas can peel off or can become thinner and delaminate. The edges of the stackup can become particularly susceptible to peeling or delamination. For example, UV light directed from one side can penetrate through the transparent substrate and transparent layers and expose the other side's passivation layer. If the total dosage of the UV light exceeds the sensitization threshold of the passivation layer, the passivation layer can peel off.

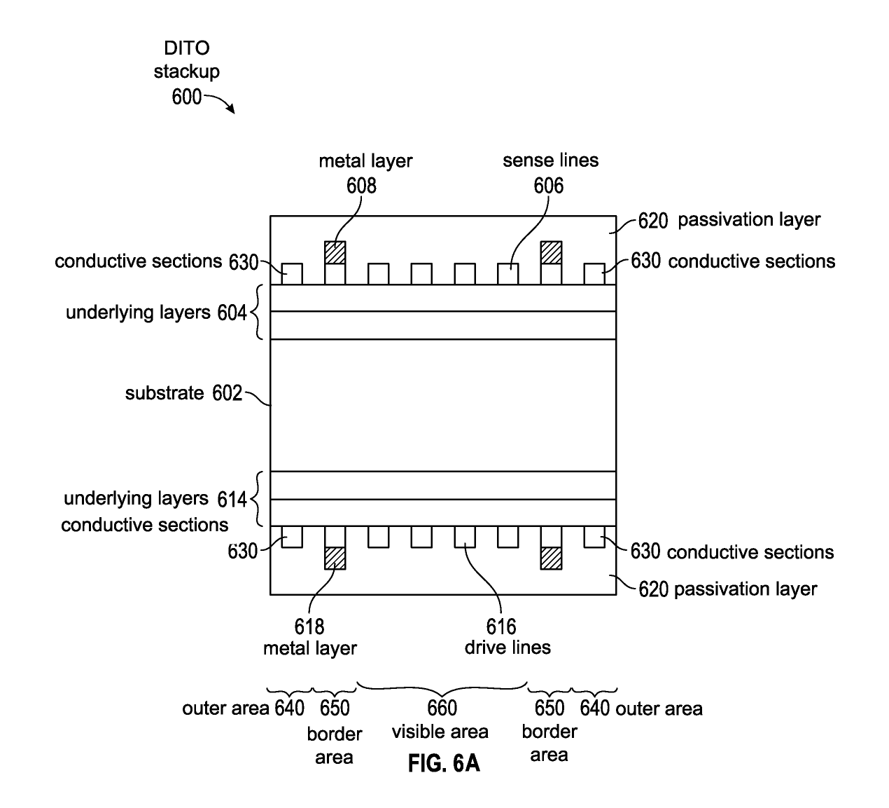

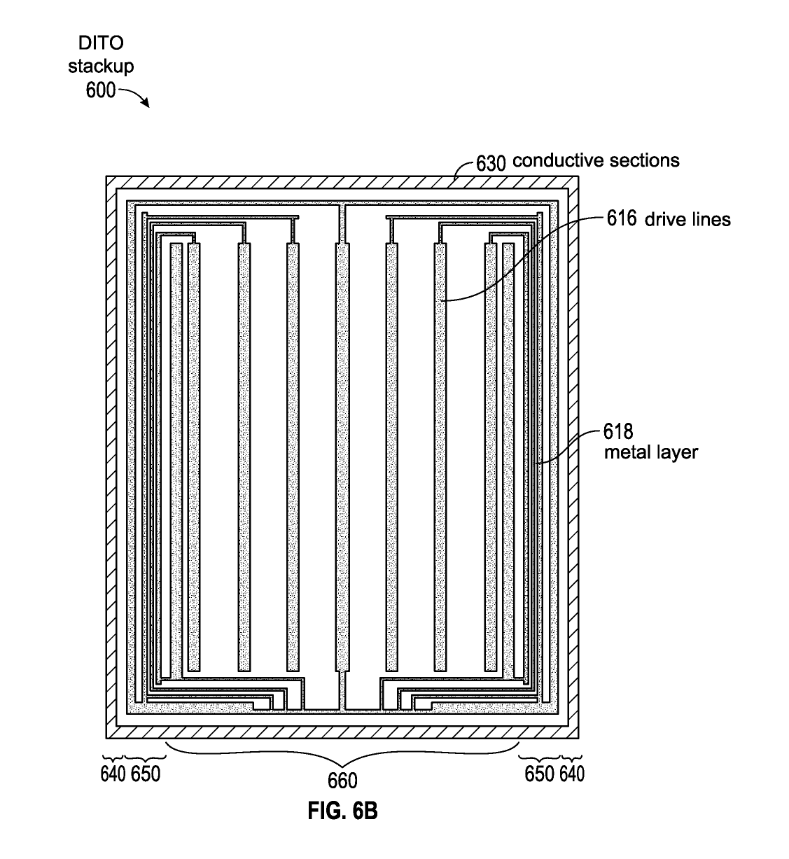

The touch sensor stackup can include one or more conductive sections to block light from partially or fully sensitizing areas of the stackup. FIG. 6A illustrates a cross-sectional view, and FIG. 6B illustrates a top view of an exemplary DITO stackup 600 with one or more conductive sections. The stackup can comprise a transparent substrate 602, one or more layers 604 and 614, sense lines 606 in the visible area 660 and metal layer 608 for routing the sense lines in the border area 650, drive lines 616 in the visible area 660 and metal layer 618 for routing the drive lines in the border area 650, and optional passivation layer 620. The stackup can include one or more conductive sections 630 disposed in the outer area 640 of the touch sensor panel. The one or more conductive sections can be any electrically conductive material. In some examples, the one or more conductive sections can be any transparent conductive film, such as Indium Tin Oxide (ITO), Indium Zinc Oxide (IZO), Zinc-doped Indium Tin Oxide (ITZO), Silver nanowires (AgNW), Silver chloride (AgCl), Carbon nanotubes (CNT), and Graphene. Additionally, the one or more conductive sections can be unconnected or electrically open to prevent increases in parasitic capacitance and/or power consumption. In some examples, the one or more conductive sections can be the same material as the drive and sense lines. In some examples, the one or more conductive sections can be on the same layer as the drive and sense lines.

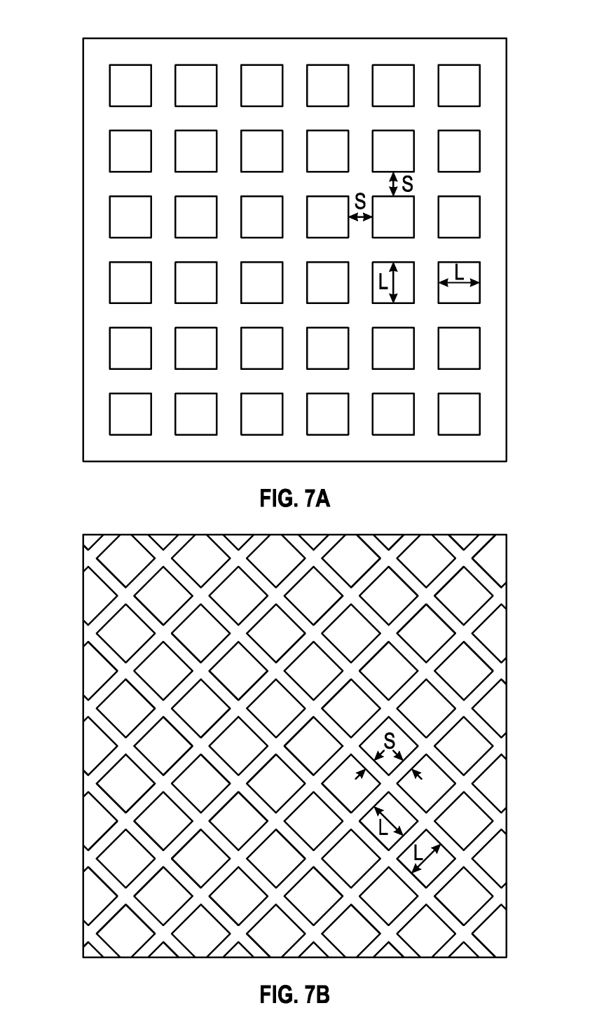

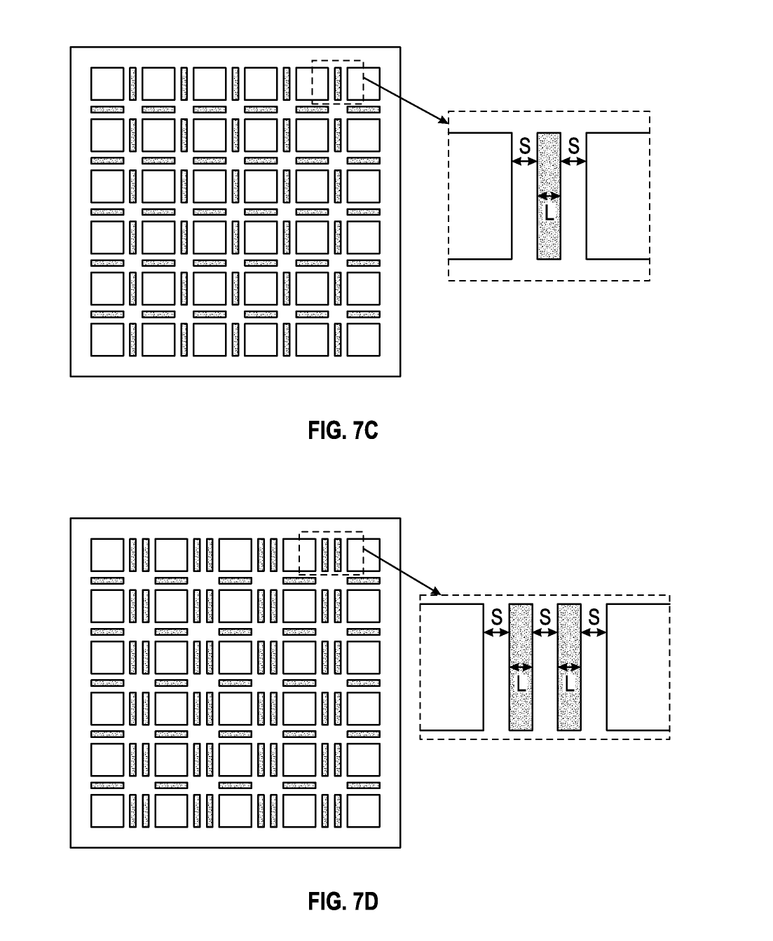

By fabricating the one or more conductive sections on the same layer and from the same material as the drive and sense lines, the number of fabrication steps and the thickness of the overall stackup need not be increased. The mask used to pattern the drive and sense lines can include a pattern for one or more conductive sections, and no changes in the manufacturing process would be required. In some examples, the one or more conductive sections can be made of a different material than the drive and sense lines. In some examples, the one or more conductive sections can be disposed on a different layer then the drive and sense lines. The one or more conductive sections can be continuous or discontinuous and can comprise one or more subsections. In some examples, the one or more conductive sections can form a continuous ring. In some examples, the width of the one or more conductive sections can range from 2-100 μm. In some examples, the one or more conductive sections can substantially occupy a full area of the outer area as long as the one or more conductive sections are spaced far enough to be electrically isolated from the metal layer located in the border area. In some examples, the spacing between the border area and the outer area can range from 1-100 μm. In some examples, the stackup can include open areas outside of the metal layer, not occupied by the one or more conductive sections. While FIG. 6A illustrates the one or more transparent conductive sections disposed between the underlying layers 604 and passivation layer 620, the one or more transparent conductive sections can be disposed anywhere in the stackup, as long as the one or more transparent conductive sections block light to prevent peeling or delamination. FIGS. 7A-7D illustrate a close up view of exemplary conductive sections. The one or more conductive sections can comprise a plurality of subsections, where the subsections can be patterned into a number of different geometric shapes, including, but not limited to, squares (shown in FIG. 7A), diamonds (shown in FIG. 7B), rectangles, and circles. The spacing between the subsections S and the length of the subsections L can be chosen based on the transmittance of light through the one or more conductive sections. In some examples, the spacing S can range from 0.5-2.5 μm. In some examples, the length of the subsections L can range from 1-4 μm. FIGS. 7C-7D illustrate exemplary one or more conductive sections comprised of graytone patterns. By employing graytone patterns, transmittance through the one or more conductive sections can be reduced because of destructive interference. While the graytone patterns illustrated in FIGS. 7C-7D comprise squares and rectangles, any number of geometric patterns and combinations of patterns can be employed. The pattern can be either positive tone or negative tone.

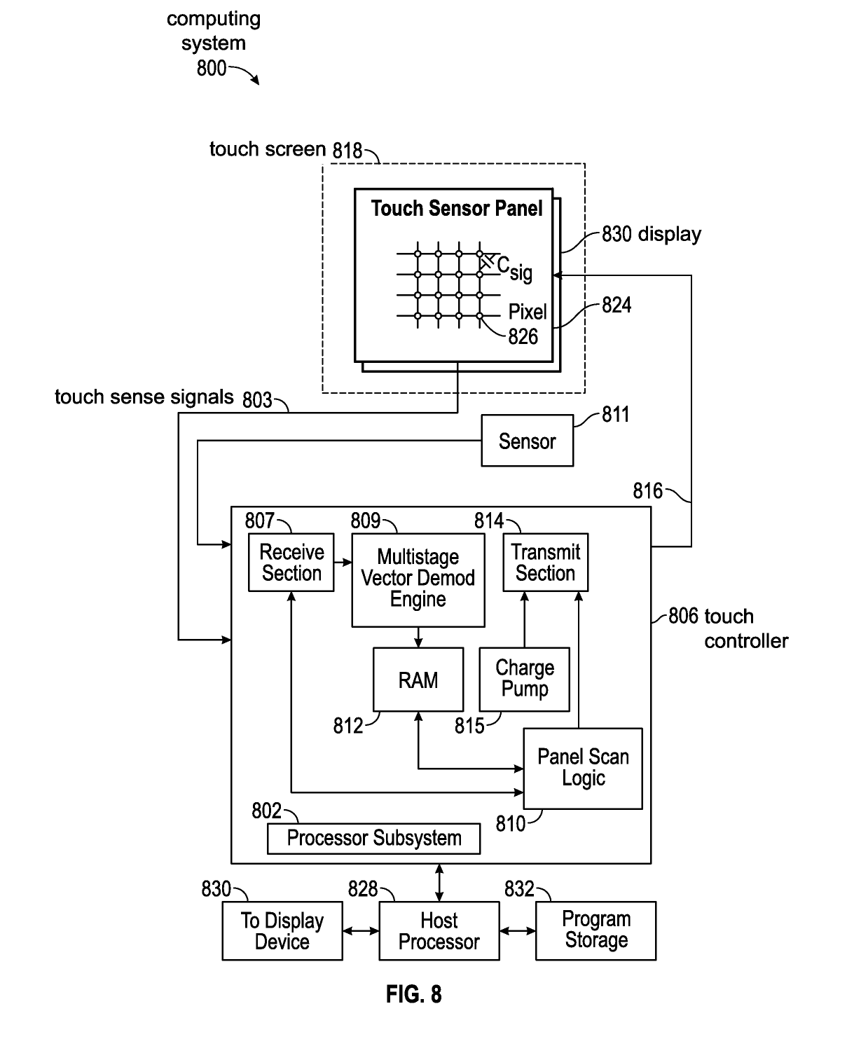

FIG. 8 illustrates exemplary computing system 800 that can utilize touch sensor panel 824 including one or more conductive sections according to various examples of the disclosure. Touch controller 806 can be a single application specific integrated circuit (ASIC) that can include one or more processor subsystems 802, which can include, for example, one or more main processors, such as ARM968 processors or other processors with similar functionality and capabilities. However, in other examples, some of the processor functionality can be implemented instead by dedicated logic, such as a state machine. Processor subsystems 802 can also include, for example, peripherals such as random access memory (RAM) 812 or other types of memory or storage, watchdog timers (not shown), and the like. Touch controller 806 can also include, for example, receive section 807 for receiving signals, such as touch sense signals 803, from the sense lines of touch sensor panel 824, and other signals from other sensors such as sensor 811, etc. Touch controller 806 can also include, for example, a demodulation section such as multistage vector demod engine 809, panel scan logic 810, and a drive system including, for example, transmit section 814. Panel scan logic 810 can access RAM 812, autonomously read data from the sense channels, and provide control for the sense channels. In addition, panel scan logic 810 can control transmit section 814 to generate stimulation signals 816 at various frequencies and phases that can be selectively applied to the drive lines of the touch sensor panel 824.

Charge pump 815 can be used to generate the supply voltage for the transmit section. Stimulation signals 816 (Vstim) can have amplitudes higher than the maximum voltage the ASIC process can tolerate by cascading transistors. Therefore, using charge pump 815, the stimulus voltage can be higher (e.g. 6V) than the voltage level a single transistor can handle (e.g. 3.6 V). Although FIG. 8 shows charge pump 815 separate from transmit section 814, the charge pump can be part of the transmit section.

Touch sensor panel 824 can include a capacitive sensing medium having a plurality of drive lines and a plurality of sense lines. The drive and sense lines can be formed from a transparent conductive medium such as Indium Tin Oxide (ITO) or Antimony Tin Oxide (ATO), although other transparent and non-transparent materials such as copper can also be used. In some examples, the drive and sense lines can be perpendicular to each other, although in other examples other non-Cartesian orientations are possible. For example, in a polar coordinate system, the sensing lines can be concentric circles and the driving lines can be radially extending lines (or vice versa). It should be understood, therefore, that the terms “drive lines” and “sense lines” as used herein are intended to encompass not only orthogonal grids, but the intersecting traces or other geometric configurations having first and second dimensions (e.g. the concentric and radial lines of a polar-coordinate arrangement). The drive and sense lines can be formed on, for example, a single side of a substantially transparent substrate.

At the “intersections” of the traces, where the drive and sense lines can pass adjacent to and above and below (cross) each other (but without making direct electrical contact with each other), the drive and sense lines can essentially form two electrodes (although more than two traces could intersect as well). Each intersection of drive and sense lines can represent a capacitive sensing node and can be viewed as pixel or node 826, which can be particularly useful when touch sensor panel 824 is viewed as capturing an “image” of touch. (In other words, after touch controller 806 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel.) The capacitance between drive and sense electrodes can appear as a stray capacitance when the given row is held at direct current (DC) voltage levels and as a mutual signal capacitance Csig when the given row is stimulated with an alternating current (AC) signal. The presence of a finger or other object near or on the touch sensor panel can be detected by measuring changes to a signal charge Qsig present at the pixels being touched, which is a function of Csig.

Computing system 800 can also include host processor 828 for receiving outputs from processor subsystems 802 and performing actions based on the outputs that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 828 can perform additional functions that may not be related to panel processing, and can be coupled to program storage 832 and display 830, such as an LCD display, for providing a user interface to a user of the device. In some examples, host processor 828 can be a separate component for touch controller 806, as shown. In other examples, host processor 828 can be included as part of touch controller 806. In other examples, the functions of host processor 828 can be performed by processor subsystem 802 and/or distributed among other components of touch controller 806. Display device 830 together with touch sensor panel 824, when located partially or entirely under the touch sensor panel, can form touch screen 818.

Note that one or more of the functions described above can be performed, for example, by firmware stored in memory (e.g. one of the peripherals) and executed by processor subsystem 802, or stored in program storage 832 and executed by host processor 828. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding a signal) that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus, or device, a portable computer diskette (magnetic), a random access memory (RAM) (magnetic), a read-only memory (ROM) (magnetic), an erasable programmable read-only memory (EPROM) (magnetic), a portable optical disc such as a CD, CD-R, CD-RW, DVD, DVD-R, or DVD-RW, or flash memory such as compact flash cards, secured digital cards, USB memory devices, memory sticks and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate, or transport the program for use by or in connection with the instruction execution system, apparatus, or device. The transport readable medium can include, but is not limited to, an electronic, magnetic, optical, electromagnetic, or infrared wired or wireless propagation medium.

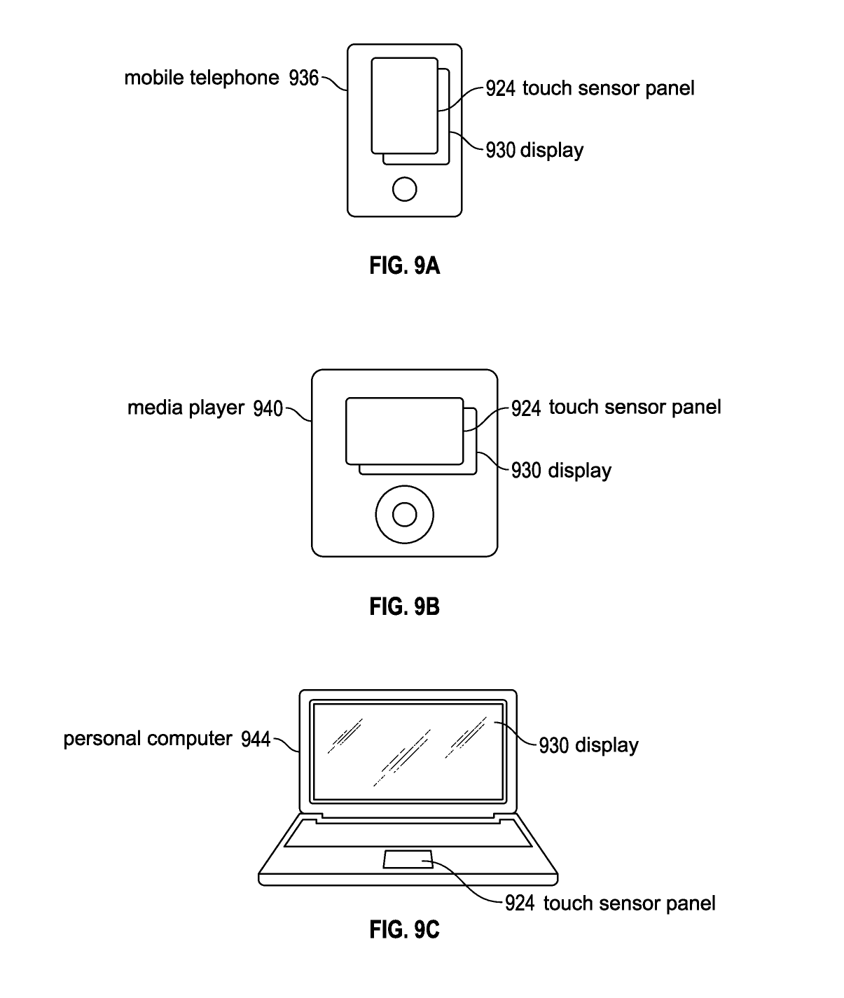

FIG. 9A illustrates an exemplary mobile telephone 936 that can include touch sensor panel 924 and display device 930. FIG. 9B illustrates exemplary media player 940 that can include touch sensor panel 924 and display device 930. FIG. 9C illustrates an exemplary personal computer 944 that can include touch sensor panel (trackpad) 924 and display 930. The touch sensor panels 924 in the FIGS. 9A-9C can include one or more conductive sections according to examples of the disclosure. In some examples, the display 930 can be part of a touch screen.

In some examples, a touch sensor panel is disclosed. The touch sensor panel may comprise: a plurality of first lines of a first conductive material; a second conductive material electrically connected to the plurality of first lines to create one or more conductive traces for off-panel connections; and one or more conductive sections disposed at least partially in an outer area of the touch sensor panel and electrically isolated from the second conductive material. Additionally or alternatively to one or more examples disclosed above, in other examples the touch sensor panel, further comprises: a plurality of second lines of a third conductive material. Additionally or alternatively to one or more examples disclosed above, in other examples the first conductive material is a same material as at least one of the second conductive material and the third conductive material. Additionally or alternatively to one or more examples disclosed above, in other examples the plurality of first lines are supported on a first substrate and the plurality of second lines are supported on a second substrate, wherein the second substrate is different from the first substrate. Additionally or alternatively to one or more examples disclosed above, in other examples the touch sensor panel, further comprises: an adhesive layer configured for adhering the first substrate to the second substrate. Additionally or alternatively to one or more examples disclosed above, in other examples the one or more conductive sections are configured to block light. Additionally or alternatively to one or more examples disclosed above, in other examples the one or more conductive sections are supported on a first side of the substrate and configured for blocking light penetrating from a second side of the substrate. Additionally or alternatively to one or more examples disclosed above, in other examples the one or more conductive sections are a continuous ring. Additionally or alternatively to one or more examples disclosed above, in other examples the one or more conductive sections include at least one of a square, diamond, rectangle, and circle. Additionally or alternatively to one or more examples disclosed above, in other examples a total length of the one or more conductive sections ranges from 1 microns to 4 microns. Additionally or alternatively to one or more examples disclosed above, in other examples a spacing between the one or more conductive sections ranges from 0.5 micron to 2.5 microns. Additionally or alternatively to one or more examples disclosed above, in other examples a total width of the one or more conductive sections ranges from 2 microns to 100 microns. Additionally or alternatively to one or more examples disclosed above, in other examples a spacing between a border area and the outer area ranges from 1 micron to 100 microns. Additionally or alternatively to one or more examples disclosed above, in other examples the one or more conductive sections form a graytone pattern. Additionally or alternatively to one or more examples disclosed above, in other examples the one or more conductive sections substantially occupy a full area of the outer area of the touch sensor panel. Additionally or alternatively to one or more examples disclosed above, in other examples the touch sensor panel, further comprises: a cover glass, wherein the plurality of first lines are supported on the cover glass. Additionally or alternatively to one or more examples disclosed above, in other examples the one or more conductive sections are formed from a transparent conductive film.

In some examples, a method of forming a touch sensor panel is disclosed. The method may comprise: forming a plurality of first lines of a first conductive material; forming a second conductive material electrically connected to the plurality of first lines to create one or more conductive traces for off-panel connections; and forming one or more conductive sections disposed at least partially in an outer area of the touch sensor panel and electrically isolated from the second conductive material. Additionally or alternatively to one or more examples disclosed above, in other examples the one or more conductive sections form a continuous ring. Additionally or alternatively to one or more examples disclosed above, in other examples the one or more conductive sections form a graytone pattern.

While various examples have been described above, it should be understood that they have been presented by way of example only, and not by way of limitation. Although examples have been fully described with reference to the accompanying drawings, the various diagrams may depict an example architecture or other configuration for this disclosure, which is done to aid in the understanding of the features and functionality that can be included in the disclosure. The disclosure is not restricted to the illustrated exemplary architectures or configurations, but can be implemented using a variety of alternative architectures and configurations. Additionally, although the disclosure is described above in terms of various examples and implementations, it should be understood that the various features and functionality described in one or more of the examples are not limited in their applicability to the particular example with which they are described. They instead can be applied alone or in some combination, to one or more of the other examples of the disclosure, whether or not such examples are described, and whether or not such features are presented as being part of a described example. Thus, the breadth and scope of the present disclosure should not be limited by any of the above-described examples.

What is claimed is:

1. A touch sensor panel comprising:
a plurality of first lines of a first conductive material;
a second conductive material electrically connected to the plurality of first lines to create one or more conductive traces for off-panel connections; and
one or more conductive sections disposed at least partially in an outer area of the touch sensor panel and electrically isolated from the second conductive material.

2. The touch sensor panel of claim 1, further comprising:
a plurality of second lines of a third conductive material.

3. The touch sensor panel of claim 2, wherein the first conductive material is a same material as at least one of the second conductive material and the third conductive material.

4. The touch sensor panel of claim 2, wherein the plurality of first lines are supported on a first substrate and the plurality of second lines are supported on a second substrate, wherein the second substrate is different from the first substrate.

5. The touch sensor panel of claim 4, further comprising:
an adhesive layer configured for adhering the first substrate to the second substrate.

6. The touch sensor panel of claim 1, wherein the one or more conductive sections are configured to block light.

7. The touch sensor panel of claim 6, wherein the one or more conductive sections are supported on a first side of the substrate and configured for blocking light penetrating from a second side of the substrate.

8. The touch sensor panel of claim 1, wherein the one or more conductive sections are a continuous ring.

9. The touch sensor panel of claim 1, wherein the one or more conductive sections include at least one of a square, diamond, rectangle, and circle.

10. The touch sensor panel of claim 1, wherein a length of at least one of the one or more conductive sections ranges from 1 microns to 4 microns.

11. The touch sensor panel of claim 1, wherein a spacing between the one or more conductive sections ranges from 0.5 micron to 2.5 microns.

12. The touch sensor panel of claim 1, wherein a total width of the one or more conductive sections ranges from 2 microns to 100 microns.

13. The touch sensor panel of claim 1, wherein a spacing between a border area and the outer area ranges from 1 micron to 100 microns.

14. The touch sensor panel of claim 1, wherein the one or more conductive sections form a graytone pattern.

15. The touch sensor panel of claim 1, wherein the one or more conductive sections substantially occupy a full area of the outer area of the touch sensor panel.

16. The touch sensor panel of claim 1, further comprising:
a cover glass, wherein the plurality of first lines are supported on the cover glass.

17. The touch sensor panel of claim 1, wherein the one or more conductive sections are formed from a transparent conductive film.

18. A method of forming a touch sensor panel comprising:
forming a plurality of first lines of a first conductive material;
forming a second conductive material electrically connected to the plurality of first lines to create one or more conductive traces for off-panel connections; and
forming one or more conductive sections disposed at least partially in an outer area of the touch sensor panel and electrically isolated from the second conductive material.

19. The method of claim 18, wherein the one or more conductive sections form a continuous ring.

20. The method of claim 18, wherein the one or more conductive sections form a graytone pattern.
